(19) United States
(12) Patent Application Publication
(10) Pub. No.: US 2021/0065124 A1
(43) Pub. Date: Mar. 4, 2021

(54) LOGGING OF CHANGES IN EMPLOYMENT STAGES OF A USER-DEFINED SEARCH POOL

(71) Applicant: Microsoft Technology Licensing, LLC, Redmond, WA (US)

(72) Inventors: Robert Reeves, Castro Valley, CA (US); Michael Jennings, San Francisco, CA (US)

(21) Appl. No.: 16/555,552

(22) Filed: Aug. 29, 2019

(51) Int. Cl. G06Q 10/10; G06F 16/28; G06F 16/2455; G06F 16/248; G06F 16/9035; G06F 16/23

(52) U.S. Cl. CPC G06Q 10/105; G06F 16/285; G06F 16/2358; G06F 16/248; G06F 16/9035; G06F 16/2455

(57) ABSTRACT

An online system server determines changes in employment stages for the employees of an organization, where the organization may have multiple employees. The online system server may store employee record in an employment history database, and implement an employment history database schema facilitate the determination of the employment movement. The employment history database schema may define that the rows of an employee history database table includes pointers, where the pointers indicate a prior employer or a subsequent employer. Using formulated queries with the employment history database schema, the online system server allows an organization to more accurately log the changes in employment stages for the employees of the organization.

### TECHNICAL FIELD

The subject matter disclosed herein generally relates to systems and methods for determining changes in employment stages within an organization and, in particular, to implementing a database schema that utilizes pointers within each row to maintain an accurate representation of an employee's employment history.

### BACKGROUND

An organization may leverage an online connection network or connection graph to build relationships among its employees. The online connection network or connection graph may allow its employees to establish connections with one another and to keep apprised of developments within the organization. The online connection network or connection graph may include thousands of employees, and may be updated according to when an employee is hired or when an employee decides to depart the organization.

The online connection network or connection graph may be particularly useful to the human resource managers of the organization. The movements within the online connection network or the connection graph may inform the human resource managers whether the organization is hiring a sufficient number of employees to meet demands, whether the organization is losing employees to competitors, formulate policies that retain these talented individuals and generate industries geared toward their talents.

### BRIEF DESCRIPTION OF THE DRAWINGS

Some embodiments are illustrated by way of example and not limitation in the figures of the accompanying drawings.

FIG. 1 is a block diagram illustrating a networked system, according to some example embodiments.

FIG. 2 illustrates the online system server of FIG. 1, according to an example embodiment.

FIG. 3A illustrates an example of a search pool defined with an affiliate group, according to an example embodiment.

FIG. 3B illustrates an example of when a member is considered as a hire into the search pool, according to an example embodiment.

FIG. 3C illustrates an example of when a member is considered as a departure out of the search pool, according to an example embodiment.

FIG. 3D illustrates an example of when a member is considered as internally transitioning into the search pool from the affiliate group, according to an example embodiment.

FIG. 3E illustrates an example of when a member is considered as internally transitioning out of the search pool and into the affiliate group, according to an example embodiment.

FIG. 4 illustrates a graphical representation of an employee history table stored in an employment history database, according to an example embodiment.

FIG. 5 illustrates an example of a challenge in counting internal transitions within an affiliate group, according to an example embodiment.

FIG. 6 illustrates an example of a graphical user interface displaying a report of changes in employment stages generated by the online system server using employee stage metrics, according to an example embodiment.

FIGS. 7A-7B illustrate a method, in accordance with an example embodiment, for reporting on an organization's employees' movements using an implementation of the employee history table illustrated in FIG. 4.

FIG. 8 illustrates a method, in accordance with an example embodiment, for determining various employee stage metrics for an organization.

FIG. 9 illustrates another method, in accordance with an example embodiment, for determining various employee stage metrics for an organization.

FIG. 10 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

Example methods and systems are directed to determining changes in employment stages within an organization, where the organization may have multiple employees. In particular, employee records are stored in a database, and a database schema is implemented to facilitate the determination of the employment movement. The database schema defines that the rows of an employee history database table includes pointers, where the pointers indicate a prior employer or a subsequent employer. Using formulated queries with the database schema, the disclosed systems and methods allow an organization that uses a database to maintain employee records to more accurately log changes in employment stages within the organization. The disclosed database schema has a number of technical benefits within the field of database management and design, such as increased data integrity, reliable record-keeping, more accurate accounting, and other such technical benefits.

One of the techniques employed by an online connection service is near real-time information about the members of the online connection service. Such information may include the members that attended a particular educational institution, which members are currently employed at a particular employer, the endorsements a member profile may have received for a particular skill listed by the member associated with the member profile, and so forth. Typically, online connection service provides this information by computing or determining this information prior to the request for the information. Generally, this technique is referred to as an “offline” operation or “offline” determination of the metric. The technique is considered offline because the operations or determinations occur at a predetermined time and prior to a request of the determined metrics.

However, determining changes in employment stages for one or more organizations within a specific time period can be challenging because of a large number of attributes used to perform this determination. This attributes include, but are not limited to, the name of the organization, the location of the organization, one or more job functions performed by the employees at the organization, one or more job titles possessed by employees at the organization, one or more skills listed by member profiles corresponding to the employees at the organization, a number of years of experience possessed by the employees of the organization, and the employment type of the employees of the organization (e.g., whether the employees are full-time employees or part-time employees). Given the exponential number of variations using these attributes, it would be challenging to precompute or determine employee stage metrics in an offline fashion.

Accordingly, and in one embodiment, the employee stage metrics are determined at a time subsequent to a request for the employee stage metrics.

Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

### Detailed Embodiment

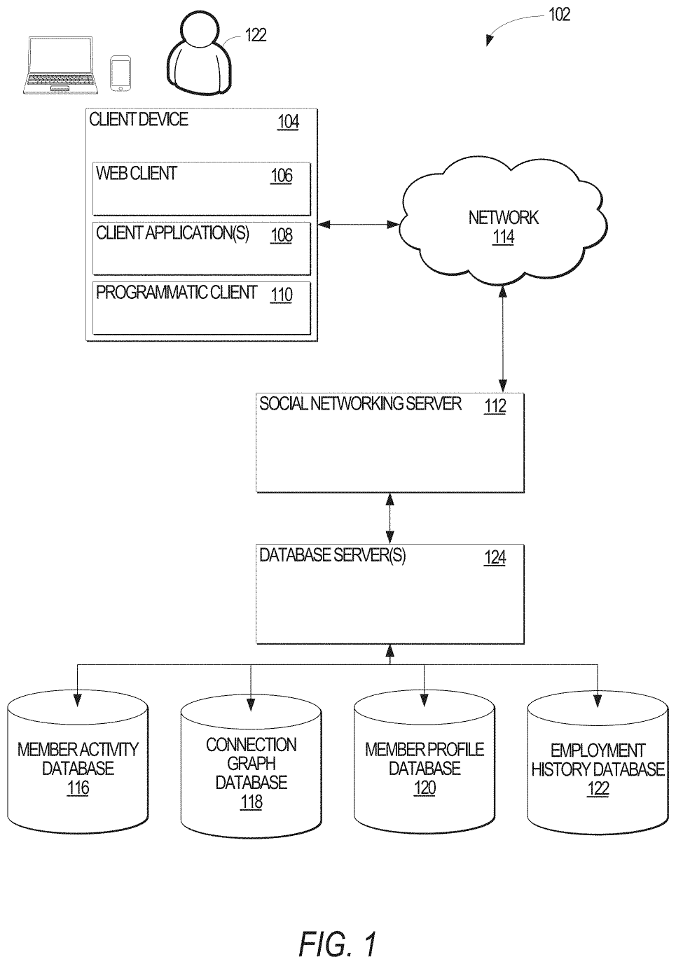

With reference to FIG. 1, an example embodiment of a high-level client-server-based network architecture 102 is shown. An online system server 112 provides server-side functionality via a network 124 (e.g., the Internet or wide area network (WAN)) to one or more client devices 104. FIG. 1 illustrates, for example, a web client 106 (e.g., a browser, such as the Internet Explorer® browser developed by Microsoft® Corporation of Redmond, Wash. State), an application 108, and a programmatic client 110 executing on client device 104. The online system server 112 is further communicatively coupled with one or more database servers 124 that provide access to one or more databases 116-120.

The client device 104 may comprise, but is not limited to, a mobile phone, desktop computer, laptop, portable digital assistants (PDAs), smart phones, tablets, ultra books, netbooks, laptops, multi-processor systems, microprocessor-based or programmable consumer electronics, or any other communication device that a user 122 may utilize to access the online system server 112. In some embodiments, the client device 104 may comprise a display module (not shown) to display information (e.g., in the form of user interfaces). In further embodiments, the client device 104 may comprise one or more of a touch screens, accelerometers, gyroscopes, cameras, microphones, global positioning system (GPS) devices, and so forth. The client device 104 may be a device of a user 122 that is used to perform one or more searches for user profiles accessible to, or maintained by, the online system server 112.

In one embodiment, the online system server 112 is a network-based appliance that responds to initialization requests or search queries from the client device 104. One or more users 122 may be a person, a machine, or other means of interacting with client device 104. In various embodiments, the user 122 is not part of the network architecture 102, but may interact with the network architecture 102 via the client device 104 or another means. For example, one or more portions of network 114 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, a wireless network, a WiFi network, a Wi Max network, another type of network, or a combination of two or more such networks.

The client device 104 may include one or more applications (also referred to as “apps”) such as, but not limited to, a web browser, messaging application, electronic mail (email) application, an online connection network access client, and the like. In some embodiments, if the online connection network access client is included in the client device 104, then this application is configured to locally provide the user interface and at least some of the functionalities with the application configured to communicate with the online system server 112, on an as needed basis, for data and/or processing capabilities not locally available (e.g., access to a member profile, to authenticate a user 122, to identify or locate other connected members, etc.). Conversely if the online system server access client is not included in the client device 104, the client device 104 may use its web browser to access the initialization and/or search functionalities of the online system server 112.

One or more users 122 may be a person, a machine, or other means of interacting with the client device 104. In example embodiments, the user 122 is not part of the network architecture 102, but may interact with the network architecture 102 via the client device 104 or other means. For instance, the user 122 provides input (e.g., touch screen input or alphanumeric input) to the client device 104 and the input is communicated to the networked system 102 via the network 114. In this instance, the online system server 112, in response to receiving the input from the user 122, communicates information to the client device 104 via the network 114 to be presented to the user 122. In this way, the user 122 can interact with the online system server 112 using the client device 104.

Further, while the client-server-based network architecture 102 shown in FIG. 1 employs a client-server architecture, the present subject matter is of course not limited to such an architecture, and could equally well find application in a distributed, or peer-to-peer, architecture system, for example.

In addition to the client device 104, the online system server 112 communicates with other one or more database server(s) 124 and/or database(s) 116-122. In one embodiment, the online system server 112 is communicatively coupled to a member activity database 116, a connection graph database 118, a member profile database 120, and an employment history database 122. The databases 116-122 may be implemented as one or more types of databases including, but not limited to, a hierarchical database, a relational database, an object-oriented database, a graph database, one or more flat files, or combinations thereof. Examples of graph databases include, but are not limited to, Neo4j, which is available from Neo Technology, Inc., Giraph, which is available from The Apache Software Foundation, and GraphLab, which is available from Dato, Inc.

The member profile database 120 stores member profile information about members who have registered with the online system server 112. Consistent with some embodiments, when a person initially registers to become a member of the online connection service provided by the online system server 112, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the member profile database 120. Similarly, when a representative of an organization initially registers the organization with the online connection service provided by the online system server 112, the representative may be prompted to provide certain information about the organization. This information may be stored, for example, in the member profile database 120. With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

Members of the online connection service provided by the online system server 112 may establish connections with one or more members and/or organizations of the online connection service. The connections may be defined as a connection graph, where the member and/or organization is represented by a node in the connection graph and the edges identify connections between nodes. In this regard, the edges may be bilateral (e.g., two members and/or organizations have agreed to form a connection), unilateral (e.g., one member has agreed to form a connection with another member), or combinations thereof. In this manner, members are said to be first-degree connections where a single edge connects the nodes representing the members; otherwise, members are said to be “nth”-degree connections where “n” is defined as the number of edges separating two nodes. As an example, two members are said to be “2nd-degree” connections where each of the members share a connection in common, but are not directly connected to one another. In one embodiment, the connection graph maintained by the online system server 112 is stored in the connection graph database 118.

Although the foregoing discussion refers to “connection graph” in the singular, one of ordinary skill in the art will recognize that the connection graph database 118 may be configured to store multiple connection graphs. For example, and without limitation, the online system server 112 may maintain multiple connection graphs, where each connection graph corresponds to various geographic regions, industries, members, or combinations thereof. As discussed below, in generating the various indices, the online system server 112 may be configured to generate a single graph or multiple graphs.

As members interact with the online connection service provided by the online system server 112, the online system server 112 is configured to log these interactions. Examples of interactions include, but are not limited to, commenting on content posted by other members, viewing member profiles, editing or viewing a member's own profile, sharing content outside of the online connection service (e.g., an article provided by an entity other than the online system server 112), updating a current status, posting content for other members to view and/or comment on, and other such interactions. In one embodiment, these interactions are stored in a member activity database 116, which associates interactions made by a member with his or her member profile stored in the member profile database 120.

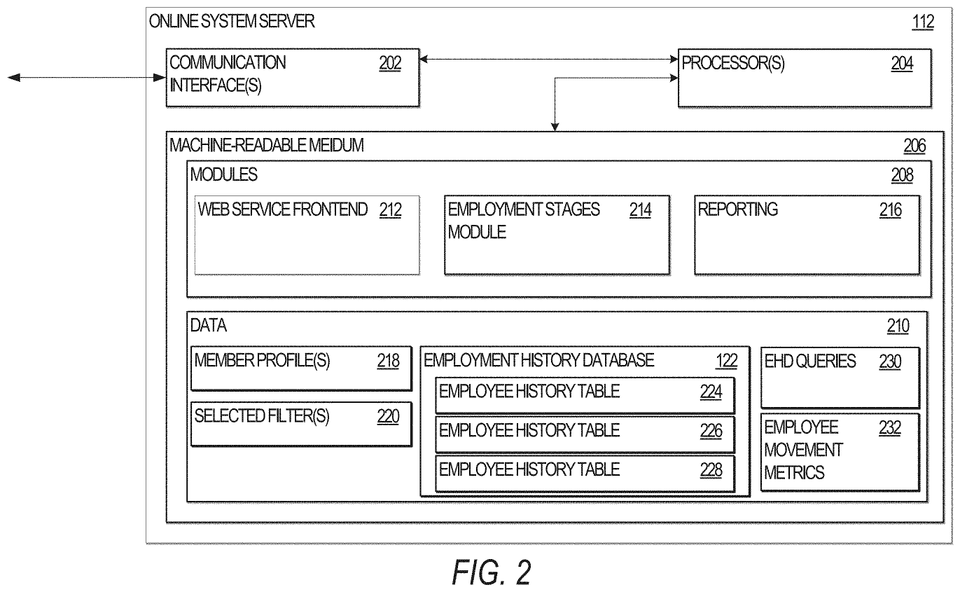

The employment history database 122 is configured to store employment history about one or more members of the online connection service. As discussed with reference to FIG. 2, below, the employment history database 122 may implement a particular database schema, where the database schema defines pointers within rows of a database table to more accurately track and report a member's employment history. In one embodiment, each member of the online connection service is associated with a unique database table within the employment history database 122, where each row within the unique database table represents an employer of the member. In another embodiment, each member of the online connection service is associated with a specific database table (which may or may not be unique), and the rows within a given database table represent an employer of the member. In yet a further implementation, the database tables of the employment history database 122 represents organizations that have registered with the online connection service, and each row of a database table represents a member that is employed by the registered organization. Alternative implementations, or combinations thereof, of the foregoing arrangement of the employment history database 122 is contemplated as falling within the scope of this disclosure.

In one embodiment, the online system server 112 communicates with the various databases 116-122 through one or more database server(s) 124. In this regard, the database server(s) 124 provide one or more interfaces and/or services for providing content to, modifying content, removing content from, or otherwise interacting with the databases 116-122. For example, and without limitation, such interfaces and/or services may include one or more Application Programming Interfaces (APIs), one or more services provided via a Service-Oriented Architecture (“SOA”), one or more services provided via a REST-Oriented Architecture (“ROA”), or combinations thereof. In an alternative embodiment, the online system server 112 communicates with the databases 116-122 and includes a database client, engine, and/or module, for providing data to, modifying data stored within, and/or retrieving data from, the one or more databases 116-122.

One of ordinary skill in the art will recognize that the database server(s) 124 may include one or more different types of servers. For example, the database server(s) 124 may include a Microsoft® Exchange Server, a Microsoft® Sharepoint® Server, a Lightweight Directory Access Protocol (“LDAP”) server, any other server configured to provide user profile information, or combinations thereof. Accordingly, and in one embodiment, the servers in communication with the online system server 112 are configured to access the various databases 116-122 and retrieve or store corresponding information.

FIG. 2 illustrates the online system server 112 of FIG. 1 in accordance with an example embodiment. In one embodiment, the online system server 112 includes one or more processor(s) 204, one or more communication interface(s) 202, and a machine-readable medium 206 that stores computer-executable instructions for one or more modules(s) 208 and data 210 used to support one or more functionalities of the modules 208.

The various functional components of the online system server 112 may reside on a single device or may be distributed across several computers in various arrangements. The various components of the online system server 112 may, furthermore, access one or more databases (e.g., databases 116-120 or any of data 210), and each of the various components of the online system server 112 may be in communication with one another. Further, while the components of FIG. 2 are discussed in the singular sense, it will be appreciated that in other embodiments multiple instances of the components may be employed.

The one or more processors 204 may be any type of commercially available processor, such as processors available from the Intel Corporation, Advanced Micro Devices, Texas Instruments, or other such processors. Further still, the one or more processors 204 may include one or more special-purpose processors, such as a Field-Programmable Gate Array (FPGA) or an Application Specific Integrated Circuit (ASIC). The one or more processors 204 may also include programmable logic or circuitry that is temporarily configured by software to perform certain operations. Thus, once configured by such software, the one or more processors 204 become specific machines (or specific components of a machine) uniquely tailored to perform the configured functions and are no longer general-purpose processors.

The one or more communication interfaces 202 are configured to facilitate communications between the online system server 112, the client device 104, and one or more of the database server(s) 124 and/or database(s) 116-122. The one or more communication interfaces 202 may include one or more wired interfaces (e.g., an Ethernet interface, Universal Serial Bus (“USB”) interface, a Thunderbolt® interface, etc.), one or more wireless interfaces (e.g., an IEEE 802.11b/g/n interface, a Bluetooth® interface, an IEEE 802.16 interface, etc.), or combination of such wired and wireless interfaces.

The machine-readable medium 206 includes various modules 208 and data 210 for implementing the online system server 112. The machine-readable medium 206 includes one or more devices configured to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store the modules 208 and the data 210. Accordingly, the machine-readable medium 206 may be implemented as a single storage apparatus or device, or, alternatively and/or additionally, as a “cloud-based” storage systems or storage networks that include multiple storage apparatus or devices. As shown in FIG. 2, the machine-readable medium 206 excludes signals per se.

In one embodiment, the modules 208 are written in a computer-programming and/or scripting language. Examples of such languages include, but are not limited to, C, C++, C#, Java, JavaScript, Perl, Python, or any other computer programming and/or scripting language now known or later developed.

With reference to FIG. 2, the modules 208 of the online system server 112 include, but are not limited to, a web service fronted module 212, an employment stages module 214, and a reporting module 216. The data 210 supporting these modules 208 include, but is not limited to, one or more selected member profile(s) 218, one or more selected filter(s) 220 for determining the changes in employment stages, the employee history database 122, where employee history tables 224-228 are accessible to the online system server 112, one or more employee history database (EHD) queries 230 that have been constructed by the employment stages module 214 based on the one or more selected filter(s) 220, and various employee stage metrics 232 that have been determined by the employment stages module 214 based on the EHD queries 230.

The web service frontend module 212 is configured to provide access to, and interactions with, the online system server 112. In one embodiment, the web service frontend module 210 provides one or more graphical user interfaces, which may be provided using the Hypertext Transfer Protocol (HTTP). The graphical user interfaces are displayable by the client device 104 and accept input from the user 122 for interacting with the online system server 112. Further still the web service frontend 210 may be configured to provide such interfaces to one or more clients displayable by the client device 104, such as the web client 106, one or more client applications 108, or the programmatic client 110. By interacting with the web service frontend 210, the user 122 can instruct the online system server 122 to generate one or more reports relating to the changes in employment stages for the employees of an organization. Further still, the web service frontend 210 is configured to generate a display of the employee stage metrics 232 determined by the employment stages module 214.

The employment stages module 214 is configured to generate the EHD queries 230 based on the member profile(s) 218 and the selected filter(s) 220. In one embodiment, the employment stages module 214 may be implemented as Apache Spark™, which is available from the Apache Software Foundation. As known to one of ordinary skill in the art, Apache Spark™ is an open-source cluster computing framework that includes various modules and APIs for streaming, Structured Query Language (SQL), machine learning and graph processing.

The employment stages module 214 executes the generated queries 230 against one or more tables 224-228 of the employment history database 122 to obtain the employee stage metrics 232. In one embodiment, and as discussed below, the employment stages module 214 may obtain an initial set of values from the employment history database 122, which the employment stages module 214 then uses to determine the employee stage metrics 232. The employment stages module 214 then communicates the employee stage metrics 232 to and/or executes, the reporting module 216, which then generates various reports that include the employee stage metrics 232. Embodiments of the data structures used in the data 210 are discussed below.

The member profile(s) 218 correspond to one or more member profiles stored in the member profile database 120. In one embodiment, when the user 122 requests an employment stages report of the employee stage metrics 232, the user 122 may select one or more filter(s) 220 that correspond to attributes for determining the employee stage metrics 232. As discussed above, the user 122 may select such filter(s) 220 as the name of the organization, the location of the organization, one or more job functions performed by the employees at the organization, one or more job titles possessed by employees at the organization, one or more skills listed by member profiles corresponding to the employees at the organization, a number of years of experience possessed by the employees of the organization, and the employment type of the employees of the organization (e.g., whether the employees are full-time employees or part-time employees).

One or more of the foregoing filters may be position specific such that the filter is related to the position. In one embodiment, the position specific filters include the name of the organization, the job functions performed by the employees at the organization, the job titles and/or occupation possessed by the employees of the organization, and the employment type of the employees at the organization. Further still, the filter values for the position specific filters may be obtained from the organization profile associated with the organization. Other filter values (e.g., the filter values for the skills and the number of years of experience) may be obtained from the member profiles stored in the member profile database 120.

The online system server 112 may allow the user 122 to manually enter or provide a value for one or more of the selected filter(s) 220. For example, the online system server 112 may allow the user 122 to manually enter the name of the organization, the location of the organization, one or more job titles possessed by employees of at the organization, or other such values for one or more of the selected filter(s) 220. Furthermore, the online system server 112 may support the searching of manually entered values.

In one embodiment, each alphanumeric character entered by the user 122 is considered a portion of a search query, and each added alphanumeric character creates a longer search query. The online system server 112 may be configured to search for values for each entered search query. For example, where the user 122 desires to obtain employee stage metrics for organizations located in a particular location, such as “California,” the strings of “C,” “Ca,” “Cal,” “Cali,” and so forth may each be treated as separate search queries to the online system server 112. The online system server 112 may then return one or more words and/or phrases that match the provided search query (e.g., “Cancun” and “California” both match the search queries of “C” and “Ca”). For example, the online system server 112 may maintain a dictionary of known words and/or phrases (e.g., a dictionary stored in the machine-readable medium 206), and may search the dictionary given the search queries entered by the user 122. The user 122 may then select the returned words and/or phrases that best match or fit the value that the user 122 had intended for a given filter.

Additionally, and/or alternatively, the web service frontend 212 may provide a graphical user interface, such as a webpage, that includes selectable values for the filter(s) 220 selectable by the user 122. The selectable values may be displayed in a graphical element, such as a drop-down menu, a list box, one or more radio button(s), etc., where the user 122 may use the graphical element to select one or more of the selectable values. In one embodiment, the online system server 112 maintains a filter value database (not shown), where filter values are associated with each of the selectable filter(s) 220. The online system server 112 may reference or query the filter value database and communicate the selectable values to the user 122 via the web service frontend 212, where the web service frontend 212 communicates the selectable values as part of the graphical user interface communicated to the client device 104. Using the graphical element, the user 122 may then select and submit the displayed filter values as the values for the selected filter(s) 220.

Using the selected filter(s) 220, the employment stages module 214 generates one or more EHD queries 230 for querying the employment history database 122. In one embodiment, the employment history database 122 includes a plurality of employee history tables 224-228, where each of the employee history tables 224-228 correspond to a particular member of the online connection service. In this implementation, the rows of each of the tables 224-228 correspond to a position of employment held by a member of the online connection service. Additionally, and/or alternatively, the employee history database 122 may comprise a single employee history table, where the employee history table comprises a plurality of rows, where each row corresponds to a position of employment held by a member of the online service. Although this disclosure refers to the structure of the employment history database 122 as comprising one or more employee history tables 224-228, one of ordinary skill in the art will appreciate that the employment history database 122 may be implemented using various data structures including, but not limited to, a hierarchical database, a relational database, an object-oriented database, a graph database, one or more flat files, or combinations thereof.

One of the challenges in implementing the employment history database 122 is that the changes in employment stages may variably change from month-to-month. For example, an employee may join an organization in one month, internally transition within the organization in another month, and then leave the organization in a later month. These changes may result in a change of an employment stage (e.g., a change in position title) and may be inaccurately double-counted (e.g., where the employee internally transitions from one position within the organization to another position within the organization).

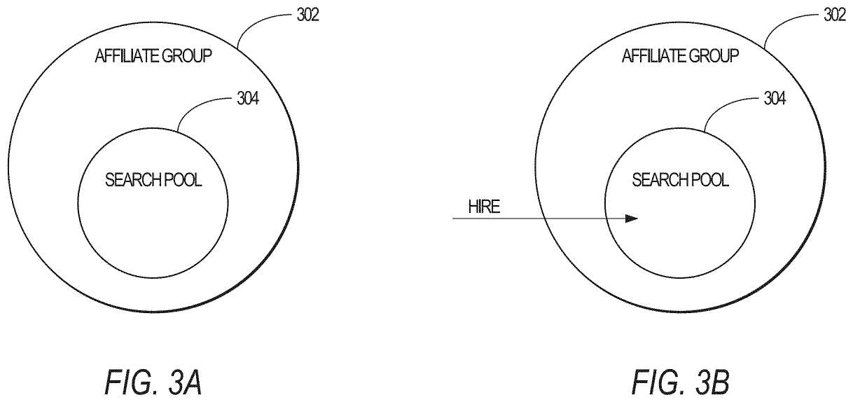

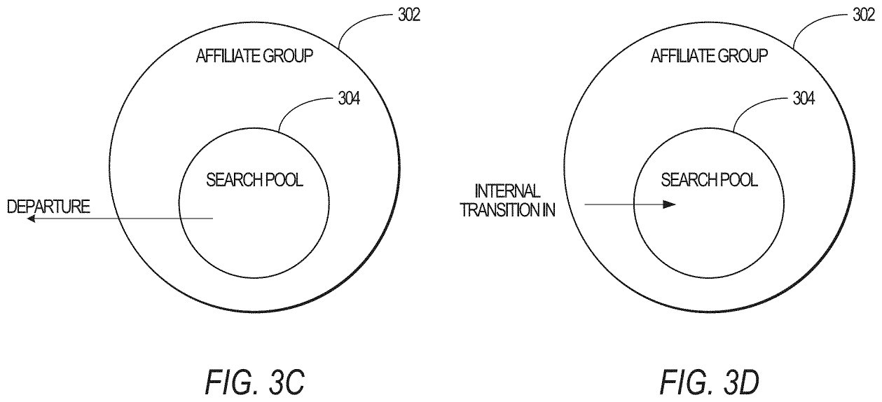

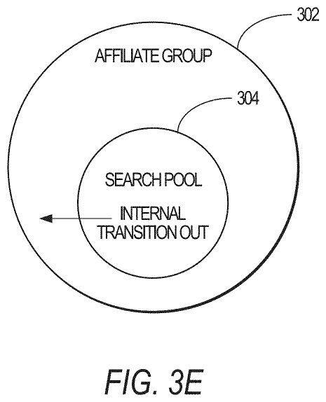

FIGS. 3A-3E illustrate the terminology used in describing changes in an employee's employment stages. FIG. 3A illustrates an example of a search pool 304 defined within an affiliate group 302, according to an example embodiment. The affiliate group 302 may represent may represent the group of organizations that are searchable by the online system server 112 and may have corresponding organizational profiles stored in one or more of the databases 116-122. Further still, the affiliate group 302 may comprise those organizations that are related to one another (e.g., one organization of the affiliate group 302 may be a subsidiary of another organization of the affiliate group 302). In one embodiment, the online system server 112 includes a data structure, such as a table, array, matrix, or other such data structure that associates organizations with their affiliates. In this manner, the online system server 112 includes an updated list of the organizations and their affiliates.

The search pool 304 represents those individual members (e.g., an employee) that have an organization from the affiliate group 302 listed in his or her employment history. In addition, the search pool 304 may comprise those members where the member profile of the member has a member profile attribute that matches one or more of the filter values for the selected filter(s) 220. For example, where the selected filter(s) 220 include an organization filter value of “Acme” and a position filter value of “Software Developer,” the search pool 304 may include those members that have a member profile that lists a “Software Developer” position with the “Acme” organization. There may also be a time element for a member to be considered within the search pool 304. For example, one or more of the selected filter(s) 220 may specify a time range for obtaining the employee stage metrics 232 for a particular organization and, if a member is not an employee of the organization during the specified time period, the member may not be considered part of the search pool 304.

FIG. 3B illustrates an example of when a member is considered as a hire into the search pool, according to an example embodiment. As shown in FIG. 3B, a member is considered a hire when the member is hired from outside of the affiliate group 302. In one instance, the member is considered a hire when the member profile corresponding to the member shows a change in an employer from the member from a previous employer to an employer that is included in the affiliate group 302. FIG. 3C illustrates an example of when a member is considered as a departure out of the search pool, according to an example embodiment. In FIG. 3C, the member is considered a departure when the member moves from inside of the affiliate group 302 to outside of the affiliate group 302 (e.g., the member does not work for an organization that is related to an organization within the affiliate group 302). The online system server 112 (e.g., the employment stages module 214) may determine the departure of the member when the member adds a new employer to his or her member profile (e.g., one of the member profile(s) 218) after a current employer (e.g., signifying that the member has been employed by the new employer) or when the member adds an end date in his or her employment history with the current employer to his or her member profile.

Referring next to FIG. 3D is an example of when a member is considered as internally transitioning into the search pool 304 from the affiliate group 302, according to an example embodiment. As shown in FIG. 3D, a member may be considered to internally transition into the search pool 304 when the member moves from the affiliate group 302 into the search pool 304. The member may move into the search pool 304 when there is a change in the member profile associated with the member. For example, the member may update one or more member profile attributes, such as employee position, a skill (e.g., “Programming,” “Needle-point,” “Accounting,” etc.), a certification or educational award, or any other such member profile attribute. Additionally, and/or alternatively, the member may move into the search pool 304 when the selected filter(s) 220 are modified (e.g., added, removed, or otherwise changed) to match with an attribute of the member that is currently outside of the search pool 304. Finally, referring to FIG. 3E, is an example of when a member is considered as internally transitioning out of the search pool 304 and into the affiliate group 302, according to an example embodiment. As with the internal transition into the search pool 304, the member may internally transition out of the search pool 304 when the member changes one or more of his or her member profile attributes, or when the user 122 selects one or more filter values for the selected filter(s) 220 that changes the scope of the member profiles that match the selected filter(s) 220.

As is evident from FIGS. 3A-3E, there are a number of ways in which an employee can register as having movement into, or out of, an organization. Accurately capturing these movements on a monthly basis is technically challenging because a traditional database is often not configured to support, and report, these types of movements. Accordingly, this disclosure describes an implementation of the employment history database 122 that accurately captures these movements and can report them in a timely fashion (e.g., within a predetermined time threshold of receiving a request for the employee stage metrics 232).

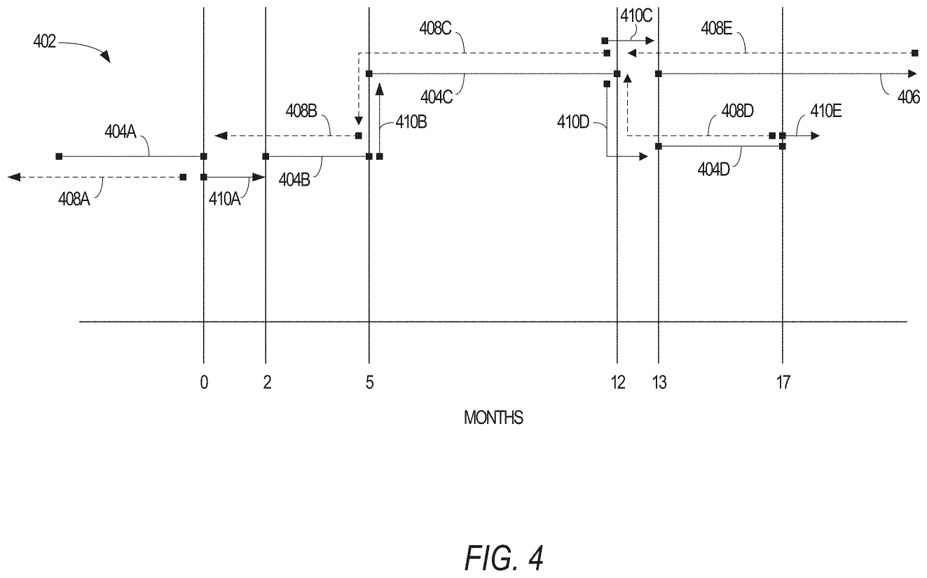

Referring now to FIG. 4 is a graphical representation 402 of an employee history table (e.g., employee history table 224) stored in the employment history database 122, according to an example embodiment. The employee history table may be implemented as a multi-row solution where pointers within each row identify a first row corresponding to previous position held by an employee at an organization and a second row corresponding to the next position held by the employee at an organization (if applicable). In addition, each row may be associated with a unique identifier that uniquely identifies the row.

The disclosed embodiments of the employment history database 122 employs a multi-row solution because, as one of ordinary skill in the art will appreciate, a single-row solution may have performance and scalability challenges. Conventionally, an employment history database table is implemented such that there is a single member position per row; in other words, there is a one-to-one correspondence between a member position and a row. Extending a one position-per-row table schema to support a headcount per month is challenging because the monthly headcount for the last month in a position depends on the context of the “next positions.” The “next positions” are the positions that the member will be in the month after the current position ends.

To illustrate this challenge, an example table is provided below that extends a conventional employment history database table to support headcount per month.

TABLE 1

| Company | Title | Start Date | End Date |
|---|---|---|---|
| Acme | Software Engin. | January 2018 | March 2018 |
| Smith & Co. | Software Engin. | April 2018 | NULL |
| Acme | Data Scientist | April 2018 | NULL |

In some instances, the database in which the employment history database table is implemented may not support queries that spawn rows or join operations. For example, it is known in the art at the time of filing this application, that Pinot does not support queries that spawn rows or join operations. Therefore, one must collapse the rows of next positions into the current position row. Additionally, a member may have more than one next position, so the employment history schema should to support a dynamic number of next positions.

In addition, one of ordinary skill in the art will appreciate that the foregoing queries do not use database JOIN operations in determining the various employee stage metrics

Given the foregoing concerns and performance issues, this disclosure contemplates an implementation of the employee history table 224 where each position held (or holdable) by the members of the online connection service are categorized into two types of rows, and there is a unique row for every position and pointer combination. In one embodiment, the rows of the employee history table 224 comprise a “start” row and an “end” row. In general, a “start” row represents a position that was held by a member of the online connection service for a period of time. In one embodiment, the time includes the month in which the member started the position (or identified as starting the position) and includes the months up until the last month in which the member held the position. The starting month (e.g., the name or numerical value of the starting month) may be presented by the variable “$start” and the ending month (e.g., the name or numerical value of the ending month) may be presented by the variable “$end”. Thus, a “start” row represents a position for months “$start” to “$end−1”. The values for $start and $end may be provided by the member of the online connection service, such as when the member updates his or her member profile with an organization

The start row may include a plurality of pointers that identify the closest position ending before the position identified by the start row started. A start row may also include a plurality of pointers that identify positions active in the month prior to the position start month. In contrast to a start row, an end row represents the last month of a closed position. The end row may include a plurality of pointers that identify the closest position starting after the position represented by the end row ended.

A position held by a member of the online connection service may be categorized as an “active” position or a “closed” position. In general, an active position refers to a position where a member of the online connection service is currently employed. In one embodiment, an active position is identifiable where the position is associated with a start date but there is no end date that indicates when the position ended. In contrast, A closed position may be considered a position that has both a start date and an end date, indicating that the member of the online connection service held the position previously. In one embodiment, an active position does not have corresponding end rows; this is because the position is still active and has not yet closed. An end row may further include a plurality of pointers that also point to the active positions in the month after the end month of the position corresponding to the end row.

To help graphically illustrate the interconnections among the start and end rows of an employment history table, FIG. 4 illustrates a graphical representation 402 that corresponds to an employment history of an example member selected from the member profile(s) 218. Although the graphical representation 402 includes a vertical axis, the vertical axis is primarily used for spacing and to ensure that the lines shown in the graphical representation 402 do not confusingly overlap. The horizontal axis of the graphical representation 402 represents time and, in the case of FIG. 4, the time is measured in months. One of ordinary skill in the art will appreciate that the horizontal axis may correspond to any other amounts of time, such as days, years, or combinations thereof.

The graphical representation 402 illustrates the relationships among the “start” rows, the “end” rows, and positions (e.g., active and closed positions) that may be implemented by one or more of the employee history tables 224-228. The positions held by the member are represented by lines 404-406, where lines 404A-404D represent closed positions. As explained above, each closed position may correspond to a row in the employee history table 224 and may be associated with “start” row and an “end” row. Lines 408A-E correspond to start rows in the employee history table 224, where the arrows of the Lines 408A-E point to a previous position held by the employee. As examples, Line 408B points to the position corresponding to Line 404A, and Line 408D points to the position corresponding to Line 404C. Where a line has an arrow that does not point to a previous position, it means that the start row has a plurality of previous position pointers having a NULL value. This situation could arise where a position is listed as the first position in an employee's employment history—thus, the employee has no previous position. Line 408A is an example where the previous position pointers in the start row may be assigned a NULL value.

FIG. 4 also illustrates the pointers of the end rows of the employee history table 224. Lines 410A-E correspond to ends rows, where the arrows of the Lines 410A-E point to a next position held by the employee. As examples, Line 410A points to the position corresponding to Line 404B, and Line 410D points to the position corresponding to Line 404D. Where a line has an arrow that does not point to a next position, it means that the end row has a plurality of next position pointers having a NULL value. This situation could arise where a position is listed as the active position in an employee's employment history—thus, the employee has no next position. Line 410E is an example where the next position pointers in the end row may be assigned a NULL value.

To implement the disclosed start and end rows, this disclosure provides for an employment history database schema that defines the pointer variables used in a start row and an end row. Below is one example of the employment history database schema, where a record with the name of MemberPositionHeadcount is defined with a plurality of fields. Each of the records and/or fields of the employment history database schema include different types of variables including, but not limited to, a “name” variable that specifies a name for a particular object or type, a “doc” variable that describes the purpose of the defined record and/or field, a “fields” object that includes one or more fields for a given record, a “type” variable that indicates a variable type for a particular object or variable, an “items” variable that specifies a variable type for items stored in a particular data construct, such as an array, and a “default” variable that indicates whether the record or variable has an initial value. The type variable may be assigned different types of values, such as a “long,” “string, “int,” “array,” and so forth, and one of ordinary skill in the art will understand that these terms connote a variable type in the art of computer science.

In the below example database schema, the name of the fields of the MemberPositionHeadCount record are given by the “name” variable.

----- BEGIN ------
{

“name”: “MemberPositionHeadcount”,
“type”: “record”,
“doc”: “Transformed member position for headcount related queries.”
“fields”: [

{

“name”: “memberId”,
“doc”: “Identifier of the member holding this position.”,
“type”: “long”

},
{

“name”: “documentType”,
“doc”: “This defines the row type. Valid RowType values are
′start′ and ′end′. A start row represents months $start to $end-
1, or $current, for a position. An end row represents month
$end for a closed position.”,
“type”: “string”

},
{

“name”: “boundaryMonthsSinceEpoch”,
“doc”: “For a start row this is the start months since epoch. For
an end row this is the end months since epoch.”,
“type”: “int”

},
{

“name”: “monthsSinceEpoch”,
“doc”: “Contains an array of months (sinceEpoch) that the

member has held this position in the last 26 months. For a start row
type this is [startMonth, ..., endMonth − 1] for closed positions and
[startMonth, ..., currentMonth] for active positions. If the startMonth
is older than 26 months ago then startMonth is replaced with
currentMonth-26. This may be performed because time series metrics
may prefer two years of data. For an end row type this is always
[endMonth].”,

“type”: {

“type”: “array”,
“items”: “int”
}

}

{

“name”: “neighborOrganizationIds”,
“doc”: “For a start row this is all organizations a member

worked at in the month prior to the position start date. For an end row
this is all organizations a member worked at in the month after the
position end date. If the end month is the current month then this will
contain organizations that are active in the current month. This may be
used to classify transitions as hire/departure or internal transition
in/out.”,

“type”: {

“type”: “array”,
“items”: “int”

},
“default”: [ ]

},
{

“name”: “organizationId”,
“doc”: “Id of the organization where the member holds this

position.”,

“type”: “int”

},

{

“name”: “titleId”,
“doc”: “The id of the title associated with this position.”,
“type”: [

“null”,
“int”

],
“default”: null

},
{

“name”: “occupationId”,
“doc”: “The occupation id associated with this position”,
“type”: [

“null”,
“int”

],
“default”: null

},
{

“name”: “functionId”,
“doc”: “The function id associated with this position.”,
“type”: [

“null”,
“int”

],
“default”: null

},
{

“name”: “industryId”,
“doc”: “The industry id associated with this position.”,
“type”: [

“null”,
“int”

],
“default”: null

},
{

“name” : “employmentTypeId”,
“type” : [ “null”, “int” ],
“doc” : “Identifies with the employment is Full time (0), Part time /

Temporary (1) and Contract / Self-employed (2).”,

“default”: null

},
{

“name”: “continentCode”,
“doc”: “The continent code where this member is currently based

represented as a lowercase two-letter continent code.”,

“type”: [

“null”,
“string”

],
“default”: null

},
{

“name”: “geoEntityIds”,
“doc”: “All geographic identifiers associated with the member

location. The elements in this field are not guaranteed to maintain the order
of the admin chain.”,

“type”: {

“type”: “array”,
“items”: “long”

},
“default”: [ ]
},

{

“name”: “geoCountryId”,
“doc”: “The geographic identifier associated with the member location

for country level rollup. The geographic entity referenced in this column has
GeoType of COUNTRY_REGION.”,

“type”: “long”,
“default”: 0

},
{

“name”: “geoRegionId”,
“doc”: “The geographic identifier associated with the member location

for region level rollup. The geographic entity referenced in this column has a
GeoType of MARKET_AREA”,

“type”: “long”,
“default”: 0

},
{

“name”: “geoCityId”,
“doc”: “The geographic identifier associated with the member location

for city level rollup. The geographic entity referenced in this column may have
a GeoType of MARKET_CIT.”,

“type”: “long”,
“default”: 0

},
{

“name”: “pointerPositionMonthsOffset”,
“doc”: “The offset between this position and the pointer position. For

start rows this is this.startMonthsSinceEpoch − pointer.
endMonthsSinceEpoch. For end rows this is pointer. startMonthsSinceEpoch
− this.endMonthsSinceEpoch.”,

“type”: [

“null”,
“int”

],
“default”: null

},
{

“name”: “pointerOrganizationId”,
“doc”: “For a start row this is the organization for a position that ended

prior to this position. For an end row this is the organization for a position that
starts after this position.”,

“type”: [

“null”,
“int”

],
“default”: null

},
{

“name”: “pointerTitleId”,
“doc”: “For a start row this is the title for a position that ended prior

to this position. For an end row this is the title for a position that starts after
this position.”,

“type”: [

“null”,
“int”

],
“default”: null

},
{

“name”: “pointerOccupationId”,
“doc”: “For a start row this is the occupation for a position that ended

prior to this position. For an end row this is the occupation for a position that
starts after this position.”,

“type”: [

“null”,
“int”

],
“default”: null

},
{

“name”: “pointerFunctionId”,
“doc”: “For a start row this is the function for a position that ended

prior to this position. For an end row this is the function for a position that
starts after this position.”,

“type”: [

“null”,
“int”

],
“default”: null

},
{

“name”: “pointerIndustryId”,
“doc”: “For a start row this is the industry for a position that ended

prior to this position. For an end row this is the industry for a position that
starts after this position.”,

“type”: [

“null”,
“int”

],
“default”: null

},
{

“name” : “pointerEmploymentTypeId”,
“type” : [ “null”, “int” ],
“doc”: “For a start row this is the employment type for a position that

ended prior to this position. For an end row this is the employment type for a
position that starts after this position.”,

“default”: null

},
{

“name”: “skillIds”,
“doc”: “The skill identifiers associated with this member.”,
“type”: {

“type”: “array”,
“items”: “int”

},
“default”: [ ]

},
{

“name”: “schoolIds”,
“doc”: “The ids of the schools the member has attended.”,
“type”: {

“type”: “array”,
“items”: “int”

},
“default”: [ ]

},
{

“name”: “highestDegreeRollupId”,
“type”: [ “null”, “int” ],
“doc”: “The degreeRollupId of this member's highest degree.”,
“default”: null

},
{

“name”: “fieldsOfStudyIds”,
“doc”: “The fields of studies ids obtained from the member's

education.”,

“type”: {

“type”: “array”,
“items”: “int”

},
“default”: [ ]

},
{

“name”: “monthsAtCompany”,
“doc”: “Total months at the current company. Calculated from

contiguous positions within the same company”,

“type”: [

“null”,
“int”

],
“default”: null

},
{

“name”: “monthsOfExperience”,
“doc”: “Months of working experience aggregated from all positions

held by the member.”,

“type”: [

“null”,
“int”

],
“default”: null

},
]

}

In one embodiment, the employment stages module 214 and/or the employment history database 122 leverages a distinct count so that the member profile(s) 218 with concurrent positions are not counted multiple times. In one implementation, distinct count keeps a set of the hash values for the objects it is counting, instead of the actual objects. It may be implemented this way to execute distinct count efficiently. For example, the employment stages module 214 and/or the employment history database 122 the distinct count may be implemented using Pinot, which is an open-source distributed relational online, analytical processing (OLAP) database management system written by LinkedIn.

One of the challenges with the distinct count implementation, is that the distinct count sacrifices some accuracy due to hash collisions. In some instances, a hash may only have 32 bits, which means that there may be a 50% chance of a collision with 77,163 values. The implications are that the employment history database 122 and/or the employment stages module 214 may consider two values the same when, in fact, these values are not actually the same.

In some instances, the search pools of the member profile(s) 218 are often greater than 77,163 members. If the employment stages module 214 queried for all metrics (e.g., headcount, hires, departures, and other such metrics disclosed herein), the numbers may not sum up properly due to the hash collisions. To address the potential problem, the employment stages module 214 is executed to compute one metric from the other metrics. This approach also has an additional benefit of reducing queries per second.

To determine the headcount per month using the example database schema above, the employment stages module 214 uses the following equation:

headcount_{month_i}=headcount_{month_i-1}+totalTransIn_{month_i}−totalTransOut_{month_i},

where
totalTransIn_{month_i}=hires_{month_i}+intTransIn_{month_i}; and
totalTransOut_{month_i}=departures_{month_i}+intTransOut_{month_i}

In the above equations, headcount represents the headcount for a particular month, totalTransIn represents the total number of transitions into the organization for a particular month, totalTransOut represents the total number of transitions out of the organization for a particular month, hires represents the number of hires for a particular month, departures represents the number of departures of a particular month, intTransIn represents the number of transitions into the organization, and intTransOut represents the number of transitions out of the organization.

To implement the foregoing equation, the employment stages module 214 uses one or more queries selected from the EHD queries 230, where inputs to the EHD queries 230 comprise the values of the selected filter(s) 220 and/or one or more attributes from a selected member profile 218. The employment stages module 214 may execute a query selected from the EHD queries 230 against the employment history database 122 and/or one or more of the employee history tables 224-228. In one embodiment, the queries of the EHD queries 230 are implemented in a query language, such as the Pinot Query Language (“PQL”), Structured Query Language (“SQL”), the MySQL query language, PostgreSQL query language, the PL/SQL query language, or any other database query language now known or later developed.

The employment stages module 214 may execute the below queries and operations to obtain changes in employment stages by month, intermediary and resulting output values may be stored in the employee stage metrics 232. To determine the changes in employment stages by month, the employment stages module 214 may execute the below seven operations, including QUERY 1, QUERY 2, QUERY 3, and QUERY 4. The operations have been commented using “##” to help explain the reasoning for a particular operation.

----- QUERY 1 - Get headcount by month -----

## ($startMonth − 1) is used because the previous month headcount is

required to calculate intTransInᵢ so the employment stages module 214 needs to get
the headcount for one additional month

## an example of <selected filters> is <titleId IN ($titleId1, $titleId2)”
## an example of <pointer position selected filters>) is ““pointerTitleId

IN ($titleId1, $titleId2)”

SELECT DISTINCTCOUNT(memberId) FROM memberPositionHeadcount

WHERE (monthsSinceEpoch BETWEEN $startMonth − 1 AND $endMonth)

AND (organizationId IN ($company1, ..., $companyN))
AND (<selected filters>)
AND (
## if this is not an end row then the month in the position always counts

towards headcount

(documentType != ″end″)
## the last month in the position counts as headcount only if the

member is in the search pool next month

## pointerPositionMonthsOffset = 1 means there is a subsequent

position and the employment stages module should check if it is in the search
pool

## if there is a gap then the employment stages module knows that the

member is not in the search pool next month

OR (pointerPositionMonthsOffset = 1 AND pointerOrganizationId IN

($company1, ..., $companyN) AND <pointer position selected filters>)
)
GROUP BY VALUEIN(monthsSinceEpoch, $startMonth − 1, ..., $endMonth)
TOP ($endMonth − $startMonth + 2)

----- END QUERY 1 -----

After the first query above, the employment stages module 214 then determines the hires and departures

--- QUERY 2 - Count the hires and departures. ---
## Groups with documentType value “start” are hires and “end” are departures.

SELECT DISTINCTCOUNT(memberId) FROM

memberPositionHeadcount WHERE (boundaryMonthsSinceEpoch BETWEEN
$startMonth AND $endMonth)

AND (organizationId IN ($company1, ..., $companyN))
AND (<selected filters>)
AND (documentType IN (“start”, “end”))
AND (neighborOrganizationIds NOT IN ($company1, ...,

$companyN))
GROUP BY boundaryMonthsSinceEpoch, documentType
TOP ($endMonth − $startMonth + 1) * 2

--- END QUERY 2 ---

Following this second query, the employment stages module 214 then determines the members of a search pool that closed a position.

--- QUERY 3 - Count all members in the search pool that closed a position. ---
SELECT DISTINCTCOUNT(memberId) FROM memberPositionHeadcount
WHERE (boundaryMonthsSinceEpoch BETWEEN $startMonth AND $endMonth)

AND (organizationId IN ($company1, ..., $companyN))
AND (<selected filters>)
AND (documentType = “end”)
GROUP BY boundaryMonthsSinceEpoch
TOP ($endMonth − $startMonth + 1)

--- END QUERY 3 ---

The employment stages module 214 then determines the members of the search pool that closed a position, but remained in the search pool the following month.

--- QUERY 4 - Count all members in search pool that closed positions, but
remained in the search pool the next month. ---
SELECT DISTINCTCOUNT(memberId) FROM memberPositionHeadcount
WHERE (boundaryMonthsSinceEpoch BETWEEN $startMonth AND $endMonth)

AND (organizationId IN ($company1, ..., $companyN))
AND (<selected filters>)
AND (documentType = “end”)
AND (pointerOrganizationId IN ($company1, ..., $companyN))
AND ((pointerPositionMonthsOffset <= 1 AND

pointerPositionMonthsOffset != NULL) AND <pointer selected filters>)

GROUP BY boundaryMonthsSinceEpoch
TOP ($endMonth − $startMonth + 1)

--- END QUERY 4 ---

The employment stages module 214 then determines the total number of transitions out of the search pool by subtracting the count determined in QUERY 3 from the count determined in QUERY 4. This value corresponds to the variable totalTransOut. The employment stages module 214 next determines the total number of internal transitions out of the search pool by computing the difference between the total transitions out of the search pool and the number of departures determined in QUERY 2 above. The value determined in this operation corresponds to the total number of internal transitions out of the search pool, intTransOut.

Using these queries and determinations, the employment stages module 214 determines the number of hires, the number of departures, and the number of internal transitions out of the search pool. These values correspond to most of the variables for the employee stage metrics 232, with the exception of the total number of internal transitions into the search pool. The employment stages module 214 thus determines this remaining variable by solving for intTransInᵢ according to the following equation:

headcountᵢ=headcountᵢ₋₁+hiresᵢ−departuresᵢ+intTransInᵢ−intTransOutᵢ

Accordingly, the foregoing operations and queries result in the employment stages module 214 determining the employee stage metrics 232 for a selected set of organizations, within a given time period, for a selected number of member profile(s) 218, and other various criterion provided by the selected filter(s) 220.

Ordinarily, explicitly counting internal transitions for an organization is a challenging task. This task can be challenging because a member can have concurrent positions or positions that also end and start at the same time. Before counting a position change as a transition in or out of the search pool, the context of every other position should be accounted for since it only takes one instance of another position staying in the search pool for a position change to not be counted as a transition.

In some instances, the web service frontend 212 may receive a request to generate the employee stage metrics 232, where the user 122 has selected a minimum set of filters 220. In one embodiment, the minimum set of filters 220 is defined as the organization name and the time period for the requested employment stages report (e.g., a start month and an end month).

Where the request indicates that the minimum set of filters 220 has been selected, and the requested report is for an entire affiliate group, internal transitions do not exist and the employment stages module 214 may omit queries relating to other filters. The employment stages module 214 then determines the hires metric (e.g., hiresᵢ) because it is more efficient to query departures since only a subset of positions are closed, and the employment stages module 214 can file by documentType “end” (e.g., the “documentType” variable for a given record). Accordingly, in this implementation, the employment stages module 214 executes various EHD queries 230, which are different from the queries presented above. Examples of the EHD queries 230 that the employment stages module 214 may execute where there are no selected filters and the requested report is for the entire affiliate group are presented below, including QUERY 5 and QUERY 6. The queries and other operations have been commented using “##” to help explain the reasoning for a particular operation.

--- QUERY 5 - Get headcount by month ---
##($startMonth − 1) is used because the previous month headcount is required to
calculate hiresᵢ.
SELECT DISTINCTCOUNT(memberId) FROM memberPositionHeadcount
WHERE (monthsSinceEpoch BETWEEN $startMonth − 1 AND $endMonth)

AND (organizationId IN ($company1, ..., $companyN))
AND (

(documentType != “end”)
OR (pointerPositionMonthsOffset = 1 AND pointerOrganizationId IN

($company1, ..., $companyN))
)

GROUP BY VALUEIN(monthsSinceEpoch, $startMonth − 1, ..., $endMonth)
TOP ($endMonth − $startMonth + 2)
--- END QUERY 5---
--- QUERY 6 - Count the departures ---
SELECT DISTINCTCOUNT(memberId) FROM memberPositionHeadcount
WHERE (boundaryMonthsSinceEpoch BETWEEN $startMonth AND $endMonth)

AND (organizationId IN ($company1, ..., $companyN))
AND (documentType IN (“end”))
AND (neighborOrganizationIds NOT IN ($company1, ..., $companyN))

GROUP BY boundaryMonthsSinceEpoch
TOP ($endMonth − $startMonth + 1)
--- END QUERY 6 ---

Based on the output values produced by QUERY 6 and QUERY 7 above, the employment stages module 214 then determines the hires for $startMonth to $endMonth, where the number of hires is determined by the following equation:

hiresᵢ=headcountᵢ−headcountᵢ₋₁+departuresᵢ

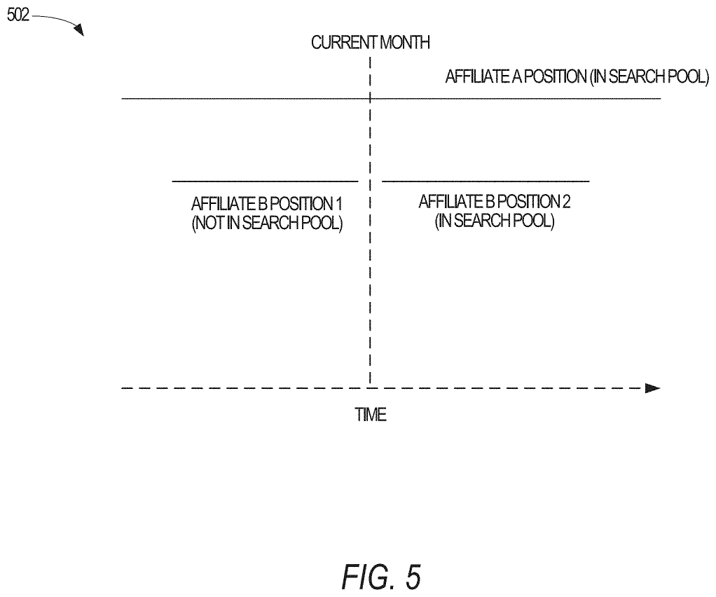

FIG. 5 illustrates an example 502 of a challenge in counting internal transitions within an affiliate group, according to an example embodiment. As shown in FIG. 5, a member has a first position with a first Affiliate of the search group for a selected time period. During that selected time period, the member initially starts with a first position with a second Affiliate, but then later transitions to a second position with the second Affiliate. However, the transition of the first position to the second position with the second Affiliate causes the member to belong to the search pool. Ordinarily, it would be difficult to exclude the transition (Affiliate B, Position 1) to (Affiliate B, Position 2) from the headcount for the current month because (Affiliate A, position) is in the search pool the entire time.

Alternatively, it is easy to count members who stay in the search pool because it only requires finding one instance of them staying in the search pool. The context of other positions does not matter. One embodiment of determining internal transitions is presented below.

First, the employment stages module 214 queries the employment history database 122 to count all distinct members that have a position end for a given or selected month. This first group represents a pool of members that potentially exited the search pool (e.g., departures). The employment stages module 214 then queries the employment history database 122 to count all of the members that ended positions, but stayed in the search pool. The employment stages module 214 then computes the difference in the values output by these queries to obtain a value representing all members who transitioned out of the search pool. The departures are subtracted from the total transitions out to get the internal transitions out of the search pool.

The foregoing implementation works with internal transitions in or out of the search pool. Since the majority of positions in the most recent 24 months are active, transitions out were chosen because it means scanning fewer rows in the employment history database 122. Using this information, the employment stages module 214 is able to solve for the internal transitions into the search pool using this equation.

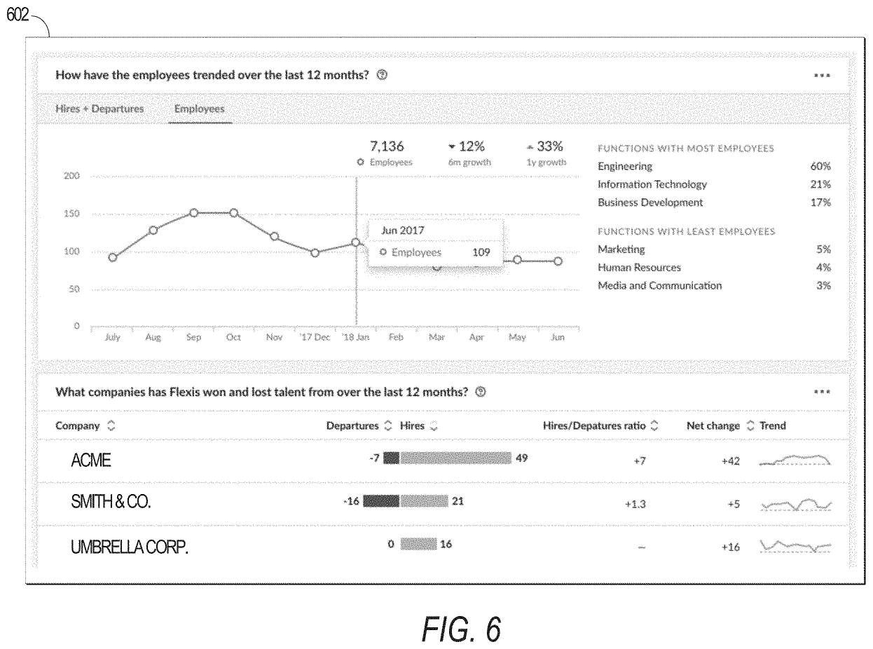

FIG. 6 illustrates an example of a graphical user interface 602 displaying an employment stages report generated by the online system server 112 using the employee stage metrics 232, according to an example embodiment. In one embodiment, the reporting module 216 is configured to generate the report illustrated in FIG. 6 in response to a request received by the web service frontend 212. The reporting module 216 retrieves the employee stage metrics 232 and generates a chart and/or webpage based on the employee stage metrics 232, which is then communicated to the web service frontend 212 for display by the client device 104. The reporting module 216 may be implemented using one or more reporting technologies, such as the REST API for Tableau Server, which is available from Tableau Software located in Seattle, Wash.

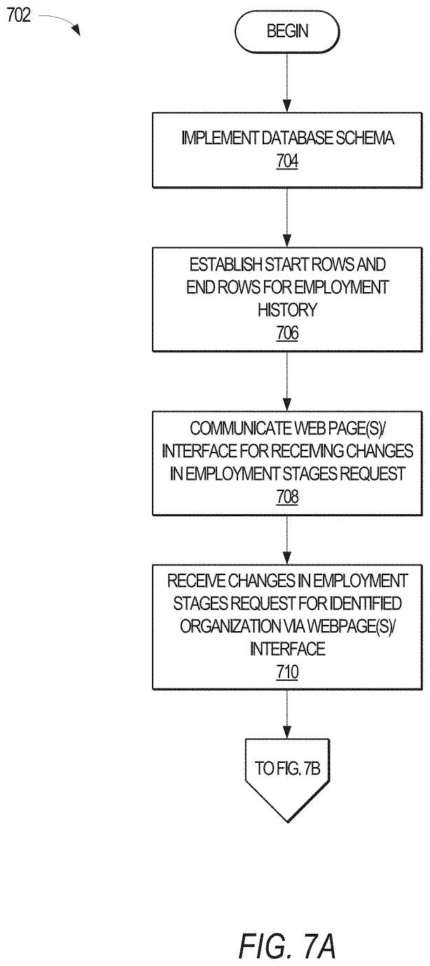

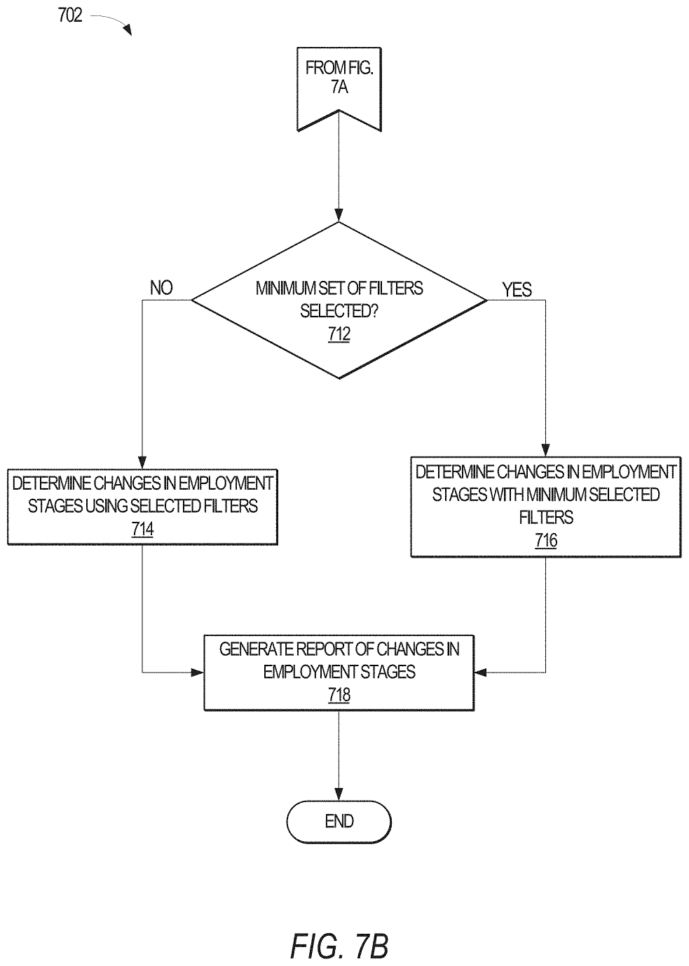

FIGS. 7A-7B illustrate a method 702, in accordance with an example embodiment, for reporting on an organization's employees' movements using an implementation of the employee history table illustrated in FIG. 4. The method 702 may be implemented using one or more of the components illustrated in FIGS. 1-2, and is discussed by way of reference thereto.

Referring initially to FIG. 7A, an administrator or other operating instantiates the employment history database 122 according to the employment history database schema discuss above (Operation 704). As explained previously, the employment history database 122 may include one or more employee history tables 224-228, where one or more of the employee history tables 224-228 comprise records of a member's employment history, where a record within the employee history tables 224-228 is instantiated as a MemberPositionHeadCount type record.

Using the employment history database schema, the employment stages module 214 may then populate one or more fields of the MemberPositionHeadCount type record with values from a selected member profile 218 (Operation 704). For example, when a member of the online connection service, the member may create a member profile 218 that includes his or her employment history. Accordingly, the employment stages module 214 may reference the created member profile and populate a MemberPositionHeadCount type record corresponding to the member with the employment history values selected from the member profile. The employment stages module 214 may also update the MemberPositionHeadCount type record in response to predetermined actions by the member, such as when the member updates his or her employment history. In this manner, the employment stages module 214 is configured to populate and/or update the employee history database 122 according to the interactions of the members of the online connection service.

When the client device 104 interacts with the online system server 112, the online system server 112 may communicate one or more webpages to the client device 104 for requesting a report of the employee stage metrics 232 for one or more organizations. As explained previously, the web service frontend 212 is configured to deliver these webpages and receive responses from the client device 104. Accordingly, at Operation 708, the web service frontend 212 communicates the one or more webpages for requesting the report of the employee stage metrics 232 (Operation 708) and receives the request accordingly (Operation 710).

The request may include an instruction for the employment stages module 214 to generate the employee stage metrics 232. In addition to selecting an organization associated with the employee stage metrics 232, the request may also include one or more selected filter(s) 220 that the employment stages module 214 uses in one or more queries to the employment history database 122.

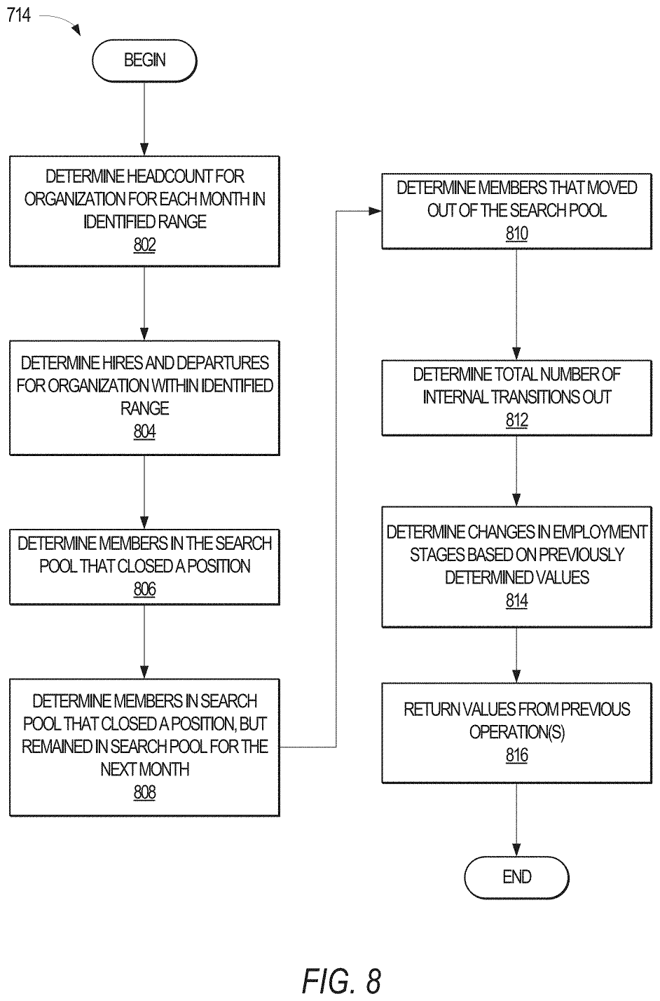

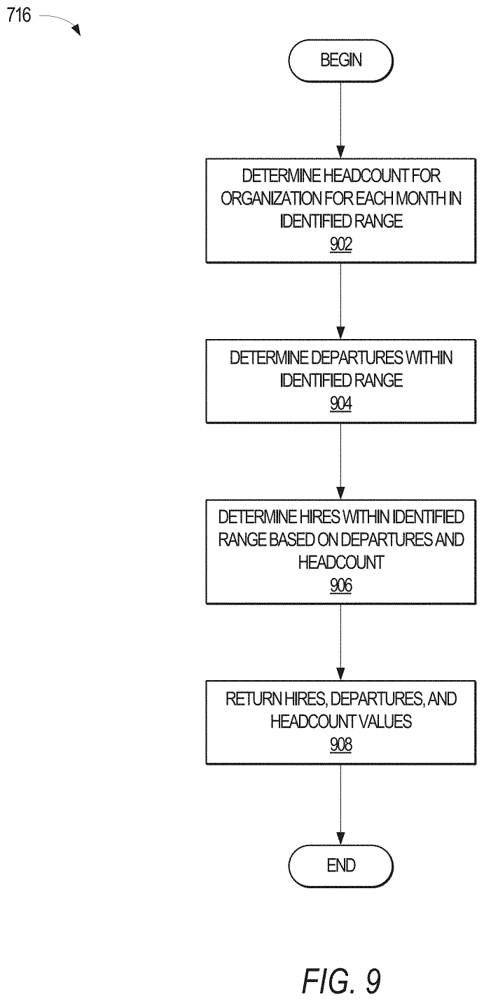

Referring next to FIG. 7B, the employment stages module 214 determines whether a minimum set of filters has been selected (Operation 712). As explained above, the minimum set of filters may include an organization name (or organization names) and a specified time period. Thus, in this embodiment, the employment stages module 214 determines that the minimum set of filters has been selected when there are values only for the organization and the time period. In other embodiments, the minimum set of filters may include additional and/or alternative filters.

Where the employment stages module 214 determines that the minimum set of filters has been selected (e.g., the “YES” branch of Operation 712), the method 702 proceeds to Operation 716, where the employment stages module 214 executes one or more of the EHD queries 230 that are associated with the minimum set of filters (Operation 716). One embodiment of the queries performed by the employment stages module 214 at Operation 716 is discussed further with reference to FIG. 9. Alternatively, where the employment stages module 214 determines that the minimum set of filters has not been selected (e.g., the “NO” branch of Operation 712), the method 702 proceeds to Operation 714, where the employment stages module 214 executes the EHD queries 230 where more than the minimum set of filters has been selected (Operation 714). One embodiment of the queries performed by the employment stages module 214 at Operation 714 is discussed further with reference to FIG. 8.

After the employment stages module 214 has determined the employee stage metrics 232, the employment stages module 214 executes and/or instructs the reporting module 216 to generate one or more reports from the employee stage metrics 232. The reporting module 216 may communicate the generated report to the web service frontend 212, which may embed an interactive version of the report in a graphical user interface, such as a webpage, for display by the client device 104. The user of the client device 104 may then interact with the generated report to explore the various employee stage metrics 232 determined by the employment stages module 216. As discussed above, one example of a graphical user interface that includes a generated report is illustrated in FIG. 6.

FIG. 8 illustrates a method 714, in accordance with an example embodiment, for determining various employee stage metrics for an organization. The method 714 may be implemented using one or more of the components illustrated in FIGS. 1-2, and is discussed by way of reference thereto.

The method 714 illustrates the various Operations 802-816 that the employment stages module 214 may perform at Operation 714 of FIG. 7. Furthermore, one of ordinary skill in the art will recognize that Operations 802-816 correspond to QUERY 1-4 and the computations associated with these queries.

Initially, the employment stages module 214 determines a headcount for each organization for each month in the identified range of months (e.g., the months selected by the user 122) (Operation 802). The employment stages module 214 then determines the hires and the departures for each organization within the identified range (Operation 804). Following this operation, the employment stages module 214 next determines the members of the online connection service that closed a position with each of the organizations named in the request (Operation 806). Thereafter, the employment stages module 214 determines which of the members in the search pool closed a position, but remained in the search pool for the next month (Operation 808).

The employment stages module 214 then determines which of the members of the search pool moved out of the search pool (Operation 810). Following Operation 810, the employment stages module 214 determines a total number of members that internally transitioned out of the search pool (Operation 812). Thereafter, the employment stages module 214 determines the monthly movement totals based on the values determined in the prior operations (Operation 814). These values are then returned (e.g., via an organized data structure, such as an array) for reporting via the reporting module 216 (Operation 816). Throughout the foregoing operations the resulting values, and any intermediary values, may be stored as the employee stage metrics 232.

FIG. 9 illustrates another method 716, in accordance with an example embodiment, for determining various employee stage metrics for an organization. The method 716 may be implemented using one or more of the components illustrated in FIGS. 1-2, and is discussed by way of reference thereto.

The method 716 illustrates the various operations that the employment stages module 214 may perform at Operation 716 of FIG. 7. Furthermore, one of ordinary skill in the art will recognize that Operations 902-908 correspond to QUERY 5-6 and the computations associated with these queries.

Initially, the employment stages module 214 determines a headcount for each organization for each month in the identified range of months (e.g., the months selected by the user 122) (Operation 902). The employment stages module 214 then determines the departures for each organization within the identified range (Operation 904). Following this operation, the employment stages module 214 next determines the hires with each of the organizations named in the request based on the departures determined in Operation 904 and for the time period specified in the request (Operation 906). Thus, each month in the specified time period is associated with a headcount value, a hires values, and a departures value.

These values are then returned (e.g., via an organized data structure, such as an array) for reporting via the reporting module 216 (Operation 908). Throughout the foregoing operations the resulting values, and any intermediary values, may be stored as the employee stage metrics 232.

In this manner, the disclosed systems and methods implement a technical solution for determining employee stage metrics for an affiliate group where the limitations of the database functionalities can hinder accurate determinations of these employee stage metrics. To address these challenges, this disclosure provides for a novel database schema that implements start rows and end rows, where the start rows and end rows including pointers to next position rows and previous position rows. Having these types of rows allows the disclosed systems and methods to provide a more accurate accounting of changes in employment stages than was previously possible. These improvements are technical because they affect the underlying data structure and manner in which a database, such as the employment history database 122, organizes the data used to store employment history. Furthermore, more accurate determinations and calculations allow a business to better predict hiring needs and to allocate budgets and funding accordingly. Thus, the technical improvements disclosed herein have an economic impact that certain types of employees, such as business owners, managers, hiring personnel, accountants, and so forth, will find beneficial to the overall success of the business.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications and so forth described in conjunction with FIGS. 1-10 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things.” While yet another combination produces a server computer for use within a cloud computing architecture. Not all combinations of such software and hardware architectures are presented here as those of skill in the art can readily understand how to implement the invention in different contexts from the disclosure contained herein.

### Example Machine Architecture and Machine-Readable Medium

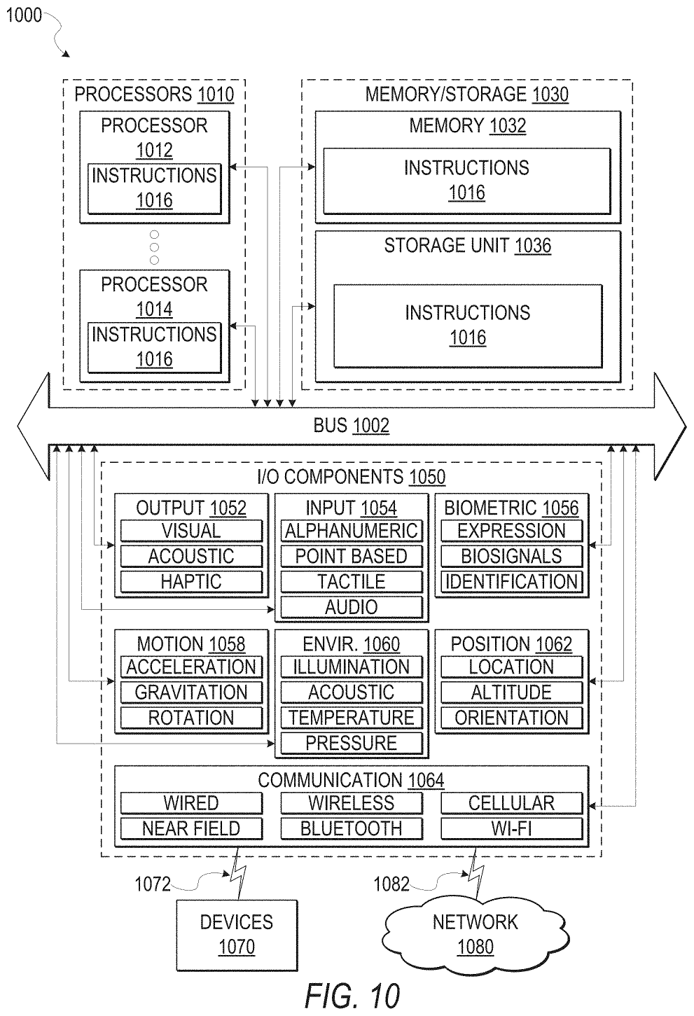

FIG. 10 is a block diagram illustrating components of a machine 1000, according to some example embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions may cause the machine to execute the flow diagrams of FIGS. 7A-9. Additionally, or alternatively, the instructions may implement one or more of the components of FIG. 1-2. The instructions transform the general, non-programmed machine into a particular machine programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1012 and processor 1014 that may execute instructions 1016. The term “processor” is intended to include multi-core processor that may comprise two or more independent processors (sometimes referred to as “cores”) that may execute instructions contemporaneously. Although FIG. 10 shows multiple processors, the machine 1000 may include a single processor with a single core, a single processor with multiple cores (e.g., a multi-core process), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of processors 1010 are examples of machine-readable media.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF413, Ultra Code, UCC RSS-2D bar code, and other optical codes), or acoustic detection components (e.g., microphones to identify tagged audio signals). In addition, a variety of information may be derived via the communication components 1064, such as, location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or other type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., hypertext transfer protocol (HTTP)). Similarly, the instructions 1016 may be transmitted or received using a transmission medium via the coupling 1072 (e.g., a peer-to-peer coupling) to devices 1070. The term “transmission medium” shall be taken to include any intangible medium that is capable of storing, encoding, or carrying instructions 1016 for execution by the machine 1000, and includes digital or analog communications signals or other intangible medium to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium storing computer-executable instructions; and
at least one hardware processor communicatively coupled to the machine-readable medium that, when the computer-executable instructions are executed, configures the system to perform a plurality of operations comprising:
receiving a request to determine employee stage metrics for at least one organization, wherein the request comprises a plurality of selected filter values, wherein each filter value corresponds to a selected filter;
determining whether the plurality of selected filters comprises a minimum set of predetermined filters;
in response to a determination that the plurality of selected filters comprises no more than the minimum set of predetermined filters, executing a first plurality of database queries on an employment history database using the plurality of selected filter values to obtain a first plurality of employee stage metrics;
in response to a determination that the plurality of selected filters comprises more than the minimum set of predetermined filters, executing a second plurality of database queries on the employment history database using the plurality of selected filter values to obtain a second plurality of employee stage metrics, wherein a database query of the second plurality of database queries uses a selected filter of the plurality of filters not included in the minimum set of predetermined filters;
generating an employment stages report using the first plurality of employee stage metrics or the second plurality of employee stage metrics; and
presenting the employment stages report to a client device.

2. The system of claim 1, wherein the minimum set of predetermined filters comprise filters that are specific to an employment position.

3. The system of claim 2, wherein the filters that are specific to an employment position consist of an organization name, a job function, a job title, and an employment type.

4. The system of claim 1, wherein the employee stage metrics comprise at least one of a headcount per month, a hires per month, and departures per month.

5. The system of claim 4, wherein:
in response to the determination that the plurality of selected filters comprises more than the minimum set of predetermined filters, the employee stage metrics further comprise a number of employees that internally transferred into a search pool, a number of employees that internally transferred out of the search pool, and a total number of employees that transitioned out of the search pool.

6. The system of claim 1, wherein:
the employment history database implements an employment history database schema that comprises a database field having a first type that indicates that a particular employee closed a particular position with a particular organization; and
the first plurality of queries comprises a query that references the database field having the first type.

7. The system of claim 1, wherein:
the employment history database implements an employment history database schema that comprises:
a first database field having a first type that indicates that a particular employee started a first position with a first organization; and
a second database field having a second type that indicates that a particular employee closed a second particular with a second organization; and
the second plurality of queries comprises a query that references the first database field and the second database field.

8. A method comprising:
receiving a request to determine employee stage metrics for at least one organization, wherein the request comprises a plurality of selected filter values, wherein each filter value corresponds to a selected filter;
determining whether the plurality of selected filters comprises a minimum set of predetermined filters;
in response to a determination that the plurality of selected filters comprises no more than the minimum set of predetermined filters, executing a first plurality of database queries on an employment history database using the plurality of selected filter values to obtain a first plurality of employee stage metrics;
in response to a determination that the plurality of selected filters comprises more than the minimum set of predetermined filters, executing a second plurality of database queries on the employment history database using the plurality of selected filter values to obtain a second plurality of employee stage metrics, wherein a database query of the second plurality of database queries uses a selected filter of the plurality of filters not included in the minimum set of predetermined filters;
generating an employment stages report using the first plurality of employee stage metrics or the second plurality of employee stage metrics; and
presenting the employment stages report to a client device.

9. The method of claim 8, wherein the minimum set of predetermined filters comprise filters that are specific to an employment position.

10. The method of claim 9, wherein the filters that are specific to an employment position consist of an organization name, a job function, a job title, and an employment type.

11. The method of claim 8, wherein the employee stage metrics comprise at least one of a headcount per month, a hires per month, and departures per month.

12. The method of claim 11, wherein:
in response to the determination that the plurality of selected filters comprises more than the minimum set of predetermined filters, the employee stage metrics further comprise a number of employees that internally transferred into a search pool, a number of employees that internally transferred out of the search pool, and a total number of employees that transitioned out of the search pool.

13. The method of claim 8, wherein:
the employment history database implements an employment history database schema that comprises a database field having a first type that indicates that a particular employee closed a particular position with a particular organization; and
the first plurality of queries comprises a query that references the database field having the first type.

14. The method of claim 8, wherein:
the employment history database implements an employment history database schema that comprises:
a first database field having a first type that indicates that a particular employee started a first position with a first organization; and
a second database field having a second type that indicates that a particular employee closed a second particular with a second organization; and
the second plurality of queries comprises a query that references the first database field and the second database field.

15. A machine-readable medium storing computer-executable instructions that, when the computer-executable instructions are executed, configures a system to perform a plurality of operations comprising:
receiving a request to determine employee stage metrics for at least one organization, wherein the request comprises a plurality of selected filter values, wherein each filter value corresponds to a selected filter;
determining whether the plurality of selected filters comprises a minimum set of predetermined filters;
in response to a determination that the plurality of selected filters comprises no more than the minimum set of predetermined filters, executing a first plurality of database queries on an employment history database using the plurality of selected filter values to obtain a first plurality of employee stage metrics;
in response to a determination that the plurality of selected filters comprises more than the minimum set of predetermined filters, executing a second plurality of database queries on the employment history database using the plurality of selected filter values to obtain a second plurality of employee stage metrics, wherein a database query of the second plurality of database queries uses a selected filter of the plurality of filters not included in the minimum set of predetermined filters;
generating an employment stages report using the first plurality of employee stage metrics or the second plurality of employee stage metrics; and
presenting the employment stages report to a client device.

16. The machine-readable medium of claim 15, wherein the minimum set of predetermined filters comprise filters that are specific to an employment position.

17. The machine-readable medium of claim 16, wherein the filters that are specific to an employment position consist of an organization name, a job function, a job title, and an employment type.

18. The machine-readable medium of claim 15, wherein the employee stage metrics comprise at least one of a headcount per month, a hires per month, and departures per month.

19. The machine-readable medium of claim 18, wherein:
in response to the determination that the plurality of selected filters comprises more than the minimum set of predetermined filters, the employee stage metrics further comprise a number of employees that internally transferred into a search pool, a number of employees that internally transferred out of the search pool, and a total number of employees that transitioned out of the search pool.

20. The machine-readable medium of claim 15, wherein:
the employment history database implements an employment history database schema that comprises a database field having a first type that indicates that a particular employee closed a particular position with a particular organization; and
the first plurality of queries comprises a query that references the database field having the first type.
